(19) United States
(12) Patent Application Publication
(10) Pub. No.: US 2017/0337801 A1
(43) Pub. Date: Nov. 23, 2017

(54) Electronic Reminder Device

(71) Applicant: Edward Robbins, Broomall, PA (US)

(72) Inventor: Edward Robbins, Broomall, PA (US)

(21) Appl. No.: 15/484,118

(22) Filed: Apr. 10, 2017

Related U.S. Application Data
(60) Provisional application No. 62/320,004, filed on Apr. 8, 2016.

(51) Int. Cl. G08B 21/24; G06Q 30/02

(52) U.S. Cl. CPC G08B 21/24; G06Q 30/0261

(57) ABSTRACT

An electronic reminder device for sensing approaching customers and playing a prerecorded message is provided. The electronic reminder device comprises a housing having a front surface, a first side surface, and a second side surface. A sensor mechanism is mounted to the front surface of the housing with the sensor mechanism detecting movement within a predetermined range. A recording mechanism records a message. A speaker audibly conveys the recorded messages. Upon the sensor mechanism determining movement within the predetermined range, the recorded message automatically plays through the speaker.

### CLAIM OF PRIORITY

This patent application claims priority under 35 USC 119 (e) (1) from U.S. Provisional Patent Application Ser. No. 62/320,004 filed Apr. 8, 2016, of common inventorship herewith entitled, “The Daily Reminder,” which is incorporated herein by reference as though the same were set forth in its entirety.

### FIELD OF THE INVENTION

The present invention pertains to the field of electronic reminder devices, and more specifically to the field of electronic reminder devices providing a motion activated recording and playback device featuring loop recording capabilities.

### BACKGROUND OF THE INVENTION

Household consumers seek to maximize their purchasing power whenever possible. From clipping coupons available in the Sunday newspaper to joining loyalty programs with businesses to receive discounts, saving money is of paramount concern in today's uncertain economic climate. When shopping in a grocery store, a home supply warehouse or a supercenter, it is common to spot potential buyers seeking out items that are on sale. Locating these elusive deals sometimes is challenging, especially in larger stores with acres of aisles of goods available. Wandering aimlessly, shoppers find themselves wasting valuable time seeking out weekly specials and clearance items that allow them to forgo paying full price for the things they need as well as things they want. When a shopper needs assistance from a sales associate to find these sale items, store personnel often is nowhere in sight, leaving the customer to continue his or her fruitless search or to simply leave the store in frustration.

The prior art has put forth several designs for electronic aids used in stores. Among these are:

US Patent Publication 2013/0036003 to Patrick Faith, Mark Carlson and Ayman Hammand describes methods, devices and systems for bumping a mobile device, such as a smart phone, against a fixed poster board display at a store to initiate a download of coupons, advertisements, or other benefits to the mobile device. Products are rated by a user's up or down bump or other bump patterns. Using accelerometer based inertial measurements, multiple users can control multiple mouse cursors on a large display with their mobile devices to select information to be downloaded to their mobile devices. The multiple users can bump the display to select their items simultaneously.

U.S. Pat. No. 8,314,699 to Julia Irmscher, Michael Rapp and Rainer Brenner describes methods, systems and other embodiments associated with charging merchandise items. A method of charging merchandise items includes displaying merchandise items at a consumer display so the merchandise items are handled by a consumer. A first power supply charges a portion of the display that does not include the merchandise items and a second power supply charges the merchandise items. The merchandise items are charged at the display on a multiplexed basis. An alarm is generated if the first power supply or the second power supply loses power but not if the first and second power supplies lose power.

U.S. Pat. No. 7,364,070 to Seok Kyu Chang describes a method for real time remote shopping using a real time remote shopping system that enables execution of numerous transaction steps for a customer to complete their selection and purchasing of items. The remote shopping system obtains commodity information from a handheld terminal and registers information on a customer, and sends shopping request information including the commodity information to a host server or a mobile terminal used by a worker through the wired or wireless communication device. A mobile terminal receives the shopping request information from the handheld terminal or host server and sends the shopping data processed in real time to the host server or the handheld terminal. The handheld terminal receives the shopping data from the server or the handheld terminal. The handheld terminal sends a shopping ended signal to the host server or the handheld terminal, and the final step is purchasing the items. The handheld terminal includes a handheld electronic device of the customer. The system and method is applicable to internet shopping.

None of these prior art references describe the present invention.

### SUMMARY OF THE INVENTION

It is an object of the present invention to provide an electronic reminder device having a motion activated recording and playback device featuring loop recording capabilities.

The present invention is an electronic reminder device for sensing approaching customers and playing a prerecorded message.

The electronic reminder device comprises a housing having a front surface, a first side surface, and a second side surface. A sensor mechanism is mounted to the front surface of the housing with the sensor mechanism detecting movement within a predetermined range. A recording mechanism records a message. A speaker audibly conveys the recorded messages. Upon the sensor mechanism determining movement within the predetermined range, the recorded message automatically plays through the speaker.

In addition, the present invention includes a method for sensing approaching customers and playing a prerecorded message. The method comprises providing a housing having a front surface, a first side surface, and a second side surface, positioning a recording mechanism within the housing, recording a message into the recording mechanism, mounting a sensor mechanism to the front surface of the housing, mounting a speaker to the front surface of the housing, detecting movement within a predetermined range, and automatically playing the recorded message through the speaker.

The present invention further includes an electronic reminder device for sensing approaching customers and playing a prerecorded message. The electronic reminder device comprises a housing having a front surface, a first side surface, and a second side surface. A sensor mechanism is mounted to the front surface of the housing with the sensor mechanism detecting movement within a predetermined range. The sensor mechanism has an internally contained passive infrared detector that sets up multiple zones of detection within a semicircular field of view using a lens. A recording mechanism records a message with the recorded message sharing a sales special in an immediate area on a looped recording. A speaker audibly conveys the recorded messages. Upon the sensor mechanism determining movement within the predetermined range, the recorded message automatically plays through the speaker.

### BRIEF DESCRIPTION OF THE DRAWINGS

FIG. 1 is a perspective view illustrating an electronic reminder device, constructed in accordance with the present invention, showing a motion sensor, a microphone, a power and volume switch, a record button, a charging port, and a battery indicator.

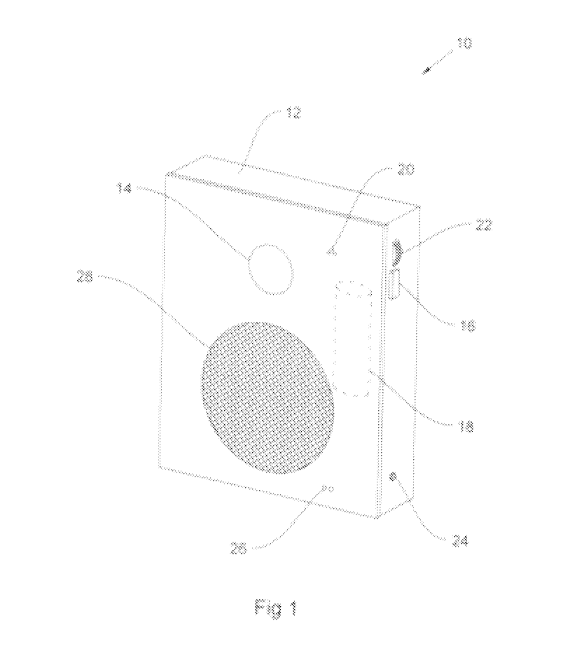

### DETAILED DESCRIPTION OF THE INVENTION

The present invention, hereinafter referred to as an Electronic Reminder Device, indicated generally at 10, providing a motion activated recording and playback device featuring loop recording capabilities. The Electronic Reminder Device 10 is placed in aisles of retail stores to sense approaching customers and play a prerecorded message sharing a sales special in the immediate area. The customer is alerted to sales items as they walk down through the store, eliminating any need to spend time and energy hunting down a sales associate.

The Electronic Reminder Device 10 of the present invention housing an outer housing 12 having a front surface, a rear surface substantially opposite the front surface, a top surface, a bottom surface substantially opposite the top surface, a first side surface between the top surface and the bottom surface, and a second side surface substantially opposite the first side surface. The housing 12 is preferably box-shaped and compact in size allowing the housing 12 to stand discretely on a horizontal surface. The housing 12 additionally preferably measures approximately five (5″) inches in height, four (4″) inches in width, and two and one quarter (2¼″) inches in depth although other dimensions are within the scope of the present invention.

In addition, the Electronic Reminder Device 10 of the present invention includes a sensor mechanism 14 mounted to the front surface of the housing 12. The sensor mechanism 14 preferably consists of an internally contained passive infrared motion detector that sets up multiple zones of detection within a semicircular field of view using a lens. While a particular type of sensor mechanism 14 having 180° of motion sensing has been described herein, it is within the scope of the present invention for the sensor mechanism 14 to be any type of motion activated sensor.

Additionally, the Electronic Reminder Device 10 of the present invention includes an external record button 16 located on either the first side or the second side of the housing 12. The external record button 16 operates an internal digital recorder 18 with looping capability. A microphone 20 on the front surface of the housing 12 or elsewhere allows a manager or store associate to verbally record sales specials into the digital recorder 18 located in the section where The Electronic Reminder Device is positioned or installed. Examples of such recordings include catchy phrases such as Stop! Jeans, two for ten dollars, buy now!, Gillette razors, twenty five percent off today only, or Look here for rock bottom clearance prices on women's shoes!

The Electronic Reminder Device 10 of the present invention further includes a speaker 28 mounted on the front surface of the housing 12 for audibly conveying the recordings ensuring the recorded messages are easily heard as soon as the customer approaches the motion sensor mechanism 14. The recordings continue on a loop, playing the same message each time motion is detected by the integrated sensor mechanism 14, so that anyone passing through the area is always aware of the sale items available. The same occurs when used in a household setting. In addition, any language can be used, as the messages are recorded by the user.

Furthermore, the Electronic Reminder Device 10 of the present invention includes an on/off dial 22 with volume control for powering the Electronic Reminder Device 10 and controlling the volume of the played recorded message. A charging port 24 is formed in the first side surface or the second side surface of the housing 12 for receiving a charging plug for charging an internal rechargeable battery. A battery indicator light 26 is positioned on the front surface of the housing 12 to inform the user of battery strength.

The Electronic Reminder Device 10 of the present invention also is effectively used by families in residential dwellings. The Electronic Reminder Device 10 will sense approaching householders and play a prerecorded message, automatically sharing messages for each family member passing by the present invention. Using the record button 16 mounted on the Electronic Reminder Device 10, a mother or father can record a message for their children when they arrive home from school and set the sensor for playback. Durably constructed of high quality materials and components, the Electronic Reminder Device 10 will withstand many years of continued use in both residential homes and retail establishments.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. An electronic reminder device for sensing approaching customers and playing a prerecorded message, the electronic reminder device comprising:
a housing having a front surface, a first side surface, and a second side surface;
a sensor mechanism mounted to the front surface of the housing, the sensor mechanism detecting movement within a predetermined range;
a recording mechanism for recording a message; and
a speaker for audibly conveying the recorded messages;
wherein upon the sensor mechanism determining movement within the predetermined range, the recorded message automatically plays through the speaker.

2. The electronic reminder device of claim 1 wherein the housing is box shaped allowing the housing to stand on a horizontal surface.

3. The electronic reminder device of claim 1 wherein the sensor mechanism has an internally contained passive infrared detector that sets up multiple zones of detection within a semicircular field of view using a lens.

4. The electronic reminder device of claim 1 wherein the recording mechanism features loop recording capabilities.

5. The electronic reminder device of claim 1 wherein the recording device has an external record button located on either the first side or the second side of the housing.

6. The electronic reminder device of claim 5 wherein the external record button operates an internal digital recorder with looping capability.

7. The electronic reminder device of claim 1 and further comprising:
a microphone positioned on the front surface of the housing.

8. The electronic reminder device of claim 1 wherein recordings includes phrases.

9. The electronic reminder device of claim 1 wherein the recorded message shares a sales special in the immediate area.

10. The electronic reminder device of claim 1 and further comprising:
an on/off dial with volume control for powering the electronic reminder device and controlling the volume of the played recorded message.

11. The electronic reminder device of claim 1 and further comprising:
a charging port formed in the first side surface or the second side surface of the housing for receiving a charging plug for charging an internal rechargeable battery.

12. The electronic reminder device of claim 1 and further comprising:
a battery indicator light positioned on the front surface of the housing to inform of battery strength.

13. A method for sensing approaching customers and playing a prerecorded message, the method comprising:
providing a housing having a front surface, a first side surface, and a second side surface;
positioning a recording mechanism within the housing;
recording a message into the recording mechanism;
mounting a sensor mechanism to the front surface of the housing;
mounting a speaker to the front surface of the housing;
detecting movement within a predetermined range; and
automatically playing the recorded message through the speaker.

14. An electronic reminder device for sensing approaching customers and playing a prerecorded message, the electronic reminder device comprising:
a housing having a front surface, a first side surface, and a second side surface;
a sensor mechanism mounted to the front surface of the housing, the sensor mechanism detecting movement within a predetermined range, the sensor mechanism having an internally contained passive infrared detector that sets up multiple zones of detection within a semicircular field of view using a lens;
a recording mechanism for recording a message, the recorded message sharing a sales special in an immediate area on a looped recording; and
a speaker for audibly conveying the recorded messages;
wherein upon the sensor mechanism determining movement within the predetermined range, the recorded message automatically plays through the speaker.

15. The electronic reminder device of claim 14 wherein the recording device has an external record button located on either the first side or the second side of the housing.

16. The electronic reminder device of claim 15 wherein the external record button operates an internal digital recorder with looping capability.

17. The electronic reminder device of claim 14 and further comprising:
a microphone positioned on the front surface of the housing.

18. The electronic reminder device of claim 1 and further comprising:
an on/off dial with volume control for powering the electronic reminder device and controlling the volume of the played recorded message.

19. The electronic reminder device of claim 14 and further comprising:
a charging port formed in the first side surface or the second side surface of the housing for receiving a charging plug for charging an internal rechargeable battery.

20. The electronic reminder device of claim 1 and further comprising:
a battery indicator light positioned on the front surface of the housing to inform of battery strength.
